(19) United States
(12) Patent Application Publication
(10) Pub. No.: US 2005/0185692 A1
(43) Pub. Date: Aug. 25, 2005

(54) Induction furnace

(75) Inventor: Peter Jeney, Zug (CH)

Correspondence Address: BACON & THOMAS, PLLC, 625 SLATERS LANE, FOURTH FLOOR, ALEXANDRIA, VA, 22314, US

(73) Assignee: RUSTEC LIMITED, Essex (GB)

(21) Appl. No.: 10/510,243

(22) PCT Filed: Apr. 16, 2003
(86) PCT No.: PCT/GB03/01649

(30) Foreign Application Priority Data
Apr. 17, 2002 (GB) 0208792.2

(51) Int. Cl. H05B 6/22

(52) U.S. Cl. 373/157

(57) ABSTRACT

An induction furnace wherein a susceptor made from an alloy comprising niobium, hafnium and titanium is positioned within the induction coil of the furnace. Such a susceptor can withstand prolonged use in an induction furnace, at high temperatures in the presence of oxygen.

The present invention relates to an induction furnace and in particular to an induction furnace which is particularly suitable for the disposal of waste materials by high temperature thermal oxidation, although it may be used in other applications, such as for example roasting of ores and minerals.

Electrically powered furnaces in which heat is produced by electrical induction are well-known. The basic structure of such furnaces comprises an electrical coil within which is placed a susceptor. Passage of alternating electrical current through the coil produces heat in the susceptor which is used to heat the furnace. A preferred material for the susceptor is graphite. However, particularly at high temperatures, graphite is attacked by oxygen and thereby eroded in use and therefore is unsuitable for use in a furnace for prolonged use at high temperatures unless oxygen is totally excluded from the furnace. Nevertheless, there are applications of such furnaces where it is either not possible to exclude oxygen or oxygen-releasing materials, or it is advantageous in the application to use controlled amounts of oxygen or other oxidizing materials. Attempts have been made to solve this problem by chemical doping of the graphite or by using materials other than graphite as the susceptor, but these have not been entirely satisfactory.

It has also been known to use various refractory materials for the purposes of heat insulation or heat shielding in induction furnaces.

The present invention seeks to provide a susceptor made from materials other than graphite which can withstand prolonged use in an induction furnace, at high temperatures in the presence of oxygen.

The present invention, accordingly provides an induction furnace wherein an alloy susceptor comprising niobium, hafnium and titanium is placed within an induction coil.

The present invention further provides the use of an induction furnace wherein an alloy susceptor comprising niobium, hafnium and titanium is placed within an induction coil in the disposal of waste materials, or roasting of ores and minerals.

The susceptor material to be used in the present invention is an alloy comprising niobium, hafnium and titanium alloy. In a preferred embodiment the alloy can further comprise zirconium. Preferably the alloy contains at least 70% niobium, 10 to 20% hafnium, up to 5% titanium, for example at least 0.1%, preferably at least 0.2% or 0.5% titanium, and 0 to 5% zirconium. In a further preferred embodiment of the invention the niobium metal containing alloy contains 10% hafnium, 1% titanium and 1% zirconium. A particularly preferred type of niobium-hafnium-titanium alloy of the present invention is that which is designated WC103 as supplied by Wah Chang. The advantage of this material in combination with induction coils lies in the fact that it has susceptor properties almost as good as graphite and is light weight and resistant to chemical influences. This chemical resistance does not require an internal surface protection layer for most applications and the alloys of this group are withstanding high stress levels at elevated temperatures of over 2000° C.

It is preferred that the susceptor is in the shape of a cylinder which forms the wall of the furnace chamber. In a further preferred embodiment of the present invention, the susceptor can be embedded within a refractory material which forms the wall of the furnace chamber.

The term “embedded” in the context of the present invention refers to the inclusion of the alloy susceptor in the cylinder of the refractory material by providing a corresponding slot in the refractory material into which the alloy susceptor can be slid. Once the alloy susceptor has been positioned, any remaining space within the slot can be filled, for example, with a suitable particulate material such as carbon black and the end of the refractory cylinder through which the alloy susceptor has been inserted can be blocked off, for example, by a cylindrical extension to the corresponding end plate of the furnace which can protrude into the cylindrical slot.

The refractory material to be used for chemically aggressive materials in the present invention is preferably chemical resistant, has high thermal shock resistance, a low coefficient of thermal expansion and refractoriness at least up to 1700° C. High purity alumina is particularly suitable although it is envisaged that other suitable materials such as advanced plasma sprayed composites can be used. When high purity alumina is used it is preferable that its purity is at least 99% and more preferable at least 99.5%. Particularly preferred types of material for use in the furnaces of the invention are those which are designated SKA 100 NG and Alsint 99.7 as supplied by the firm Haldenwanger. However, other similar materials can be used.

It is possible to use two or more susceptors in series in an induction furnace in which case each susceptor would be surrounded by a corresponding coil. For maximum efficiency the induction coil is about 1½ times the length of the susceptor and the susceptor is positioned symmetrically within the coil.

It is preferred that the coil, or coils, of the furnace are contained within a gas-tight chamber surrounding the cylindrical refractory wall of the furnace. This provides a safety factor in the unlikely event, that the wall of the refractory material should crack and release gases from the furnace chamber. In such an event the gases would still be retained within the furnace by the aforesaid gas-tight chamber which is preferably provided with means to fill it with nitrogen or some other inert gas. It also provides the ability to operate the furnace with an exactly dosed quantity of oxidizer.

The furnace will preferably be arranged to operate at a slight angle of from 1° to 20°, preferably 5°, to the horizontal so that material fed through the furnace at its upper end is assisted by gravity to move to the lower end. To further assist the progress of the material through the furnace, means are provided to rotate the cylinder about its major axis. Furthermore, the inner surface of the cylinder is preferably formed with one or more protrusions to assist progress through the furnace of the material which is being heated by the furnace, such protrusion or protrusions being preferably in the form of one or more helical flanges.

Particularly in applications such as the disposal of waste, but also in other possible applications of the furnace, it is important that the furnace provides a sealed environment and to this end rolling seals may be provided at each end of the cylinder, such seals being made of suitable steel, and further that air locks are provided also at each end of the furnace.

Regarding the use of refractory materials in the furnace, it will be appreciated that the whole of the revolving part of the furnace should be very adequately supported in order to prevent undue stresses in the refractory material.

For such applications as waste disposal it is also desirable to provide means for injecting air, oxygen, water, steam or other oxidizers or reducing agents such as hydrogen, hydrogen peroxide and hydrochloric acid, into the furnace chamber in order to control the chemistry of hydrolysis between 600° C. and 1000° C., preferably 950° C. of the particular waste disposal operation which is being performed.

With a view to controlling the furnace it is also desirable to include means for temperature measurement at a plurality of locations within the furnace chamber) by detecting and measuring heat radiation from said locations.

The induction furnace of the invention will now be illustrated by way of example with reference to the accompanying drawing in which:

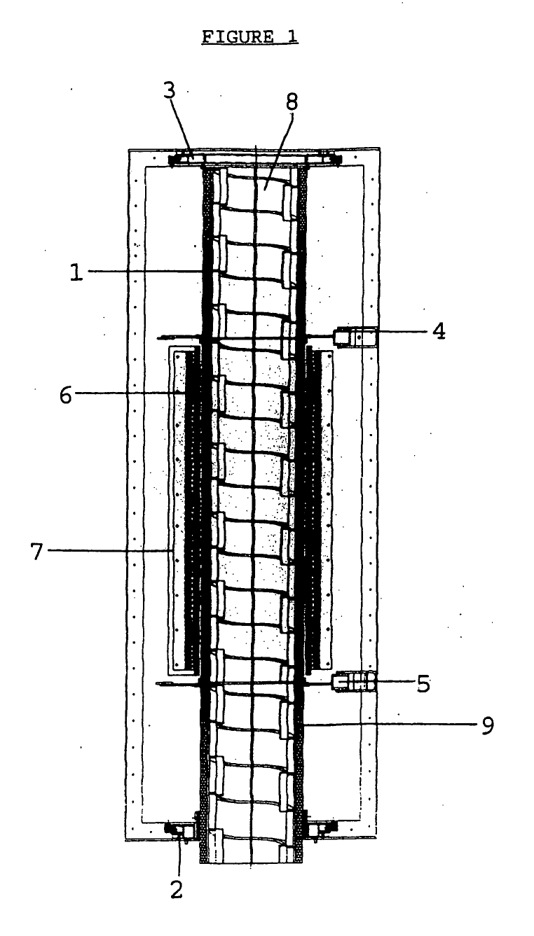

FIG. 1 is a vertical section of the main part of an induction furnace in accord with the present invention; and

In the furnace exemplified, a cylinder of an alloy comprising niobium, hafnium and titanium (1) having a length of approximately 4 metres, an internal diameter of approximately 0.5 metre and an external diameter of approximately 0.52 metre, and is held between two annular end plates (2, 3). The structure is positioned at a slight angle to the horizontal so that the plate (2) can be regarded as an upper end plate and plate (3) can be regarded as the lower end plate. The cylinder is held in position by two resistant rollers (4,5).

Surrounding cylinder (1) is an induction coil (6) having a length of approximately 2 metres and a thickness of approximately 0.015 metres. The induction coil (6) is encased in a steel cover (7) so that the system occupies a gas-tight space surrounding the furnace chamber which can be filled with nitrogen or other inert gases.

To assist the movement of material which is being heat-treated through the furnace chamber (8), a helical protrusion (9) is formed integrating with the internal surface of the cylinder.

The whole structure is mounted at each end on bearings (not shown) to provide rotation, and rolling seals and airlocks (also not shown) are also fitted at both ends of the furnace. This ancillary equipment, along with the electrical circuitry of the induction heater and also the heat radiation detector means and related control equipment are all of a conventional nature and therefore need not be described in order to enable the skilled person to operate the new furnace structure of the invention.

It will be understood that many variations could be adopted based on the specific structure hereinbefore described without departing from the scope of the invention as defined in the following claims.

1. An induction furnace wherein a susceptor made from an alloy comprising niobium, hafnium and titanium is positioned within the induction coil of the furnace.

2. An induction furnace as claimed in claim 1 wherein the alloy susceptor is cylindrical in shape, the interior surface of the cylinder forming the lining of the furnace chamber.

3. An induction furnace as claimed in claim 1 wherein the alloy susceptor is cylindrical in shape and is embedded within a cylinder of a refractory material, which forms the lining of the furnace chamber.

4. An induction furnace as claimed in claim 3, wherein the refractory material is a high purity alumina.

5. An induction furnace as claimed in claim 3 wherein the inner surface of the cylinder of refractory material is formed with one or more protrusions to assist progress through the furnace of the material which is being heated by the furnace.

6. An induction furnace as claimed in claim 5 wherein the protrusion or protrusions are in the form of one or more helical flanges.

7. An induction furnace as claimed in claim 5 wherein the cylinder is provided at each end with a rolling seal.

8. An induction furnace as claimed in claim 2 wherein means are provided to rotate the cylinder about its major axis.

9. An induction furnace as claimed in claim 1 wherein the induction coil is contained within a gas-tight chamber surrounding the cylindrical wall of the furnace.

10. An induction furnace as claimed in claim 9 wherein means are provided to fill the gas-tight chamber with nitrogen or inert gas.

11. An induction furnace as claimed in claim 1 which is provided at each end with an air lock.

12. An induction furnace as claimed in claim 1 which also comprises means for precision injection of air, oxygen, water, steam or any other oxidizer or reducing agents such as hydrogen, hydrogen peroxide and hydrochloric acid into the furnace chamber.

13. An induction furnace as claimed in claim 1 comprising means for temperature measurement at a plurality of locations within the furnace chamber by detection and measurement of heat radiation from said locations, for the purpose of furnace control.

14. An induction furnace as claimed in claim 1 wherein the alloy susceptor further comprises zirconium.

15. An induction furnace as claimed in claim 14, wherein the alloy susceptor consists of 88% niobium, 10% hafnium, 1% titanium and 1% zirconium.

16. An induction furnace as claimed in claim 1 substantially as herein before described with reference to and as illustrated in the accompanying drawing.

17. Use of a furnace as claimed in claim 1 in the disposal of waste materials, or roasting of ores or minerals.
